(19) United States
(12) Patent Application Publication
(10) Pub. No.: US 2024/0409113 A1
(43) Pub. Date: Dec. 12, 2024

(54) VEHICLE CONTROL DEVICE AND VEHICLE CONTROL METHOD

(71) Applicant: DENSO CORPORATION, Kariya-city (JP)

(72) Inventors: SHINYA AOKI, Kariya-city (JP); RIE HABUTA, Kariya-city (JP); KENJI KOHARA, Tokyo (JP); HIDEAKI FURUSE, Kariya-city (JP)

(21) Appl. No.: 18/806,531

(22) Filed: Aug. 15, 2024

Related U.S. Application Data
(63) Continuation of application No. PCT/JP2023/003999, filed on Feb. 7, 2023.

(30) Foreign Application Priority Data
Feb. 17, 2022 (JP) 2022-023247

(51) Int. Cl. B60W 50/16; B60W 30/18; B60W 50/14; G06V 20/56; G06V 20/58

(52) U.S. Cl. CPC B60W 50/16; B60W 30/18163; G06V 20/584; G06V 20/588; B60W 2050/143; B60W 2050/146; B60W 2420/403; B60W 2520/10; B60W 2552/53; B60W 2554/4041; B60W 2554/4042; B60W 2554/4045; B60W 2554/4046

(57) ABSTRACT

By a vehicle control device or a vehicle control method, whether a following vehicle, which is a different vehicle in rear of a subject vehicle and traveling in a same lane as the subject vehicle, is about to perform lane change based on a signal from a rear monitoring sensor that outputs information regarding an object existing behind the subject vehicle, and notification that the following vehicle is about to perform the lane change or cancellation or postponement of the lane change is performed.

### CROSS REFERENCE TO RELATED APPLICATIONS

The present application is a continuation application of International Patent Application No. PCT/JP2023/003999 filed on Feb. 7, 2023, which designated the U.S. and claims the benefit of priority from Japanese Patent Application No. 2022-023247 filed on Feb. 17, 2022. The entire disclosures of all of the above applications are incorporated herein by reference.

### TECHNICAL FIELD

The present disclosure relates to a technology for assisting lane change by a driver or automatically executing the lane change.

### BACKGROUND

There is a technology that uses activation of a turn signal (known as a blinker) of a subject vehicle as a trigger to detect a vehicle approaching from the rear side of the subject vehicle, and alerts the driver based on a distance and relative speed between the vehicle and the approaching vehicle. Further, a configuration of a comparative example predicts a possibility that the subject vehicle will change lanes based on a distance between the subject vehicle and the preceding vehicle or the approaching speed, and notifies the driver of the presence of a vehicle approaching from the rear based on the prediction result.

### SUMMARY

By a vehicle control device or a vehicle control method, whether a following vehicle, which is a different vehicle in rear of a subject vehicle and traveling in a same lane as the subject vehicle, is about to perform lane change based on a signal from a rear monitoring sensor that outputs information regarding an object existing behind the subject vehicle, and notification that the following vehicle is about to perform the lane change or cancellation or postponement of the lane change is performed.

### BRIEF DESCRIPTION OF THE DRAWINGS

FIG. 1 is a block diagram showing a configuration of an in-vehicle system.

FIG. 2 is a block diagram showing an example of a periphery monitoring sensor.

FIG. 3 is a functional block diagram of a vehicle control ECU.

FIG. 4 is a diagram for illustrating an example of a determination method for determining whether a following vehicle is about to perform lane change.

FIG. 5 is a flowchart corresponding to a process for determining that a following vehicle is about to perform the lane change and its movement direction based on a lateral position change amount.

FIG. 6 is a diagram for illustrating an example of a determination method for determining that the following vehicle is about to perform the lane change.

FIG. 7 is a diagram for illustrating an example of a determination method for determining that the following vehicle is about to perform the lane change.

FIG. 8 is a flowchart showing the operation of the vehicle control ECU.

FIG. 9 is a flowchart showing another example of the operation of the vehicle control ECU.

FIG. 10 is a diagram showing an example of a following vehicle warning process according to a state of a subject vehicle.

FIG. 11 is a flowchart showing another example of the operation of the vehicle control ECU.

FIG. 12 is a diagram for illustrating a distant parallelly traveling vehicle.

FIG. 13 is a flowchart for illustrating the operation of the vehicle control ECU in consideration of a behavior of a distant parallelly traveling vehicle.

### DETAILED DESCRIPTION

When the subject vehicle is about to change lanes, a vehicle following the subject vehicle may also start to change lanes. In other words, the subject vehicle and another vehicle may start to change lanes at approximately the same time. For example, there may be an obstacle such as a parked vehicle visible ahead, the vehicles are forced to move into an adjacent lane to avoid a collision. However, when a driver is about to change lanes, the driver pays attention to the traffic conditions in the adjacent lane which is the movement destination, but are unlikely to pay attention to the vehicle directly behind the subject vehicle. The driver is unlikely to notice that the vehicle behind the subject vehicle is about to change lanes.

One example of the present disclosure provides a vehicle control device and a vehicle control method capable of more safely performing lane change.

According to one example embodiment, a vehicle control device includes: a following vehicle behavior determination unit configured to determine whether a following vehicle, which is a different vehicle in rear of a subject vehicle and traveling in a same lane as the subject vehicle, is about to perform lane change based on a signal from a rear monitoring sensor that outputs information regarding an object existing behind the subject vehicle; and a vehicle controller configured to execute a following vehicle warning process that is a process of notifying a driver that the following vehicle is about to perform the lane change based on determination, by the following vehicle behavior determination unit, that the following vehicle is about to perform the lane change.

According to the above configuration, it becomes easier for the driver to recognize that the following vehicle is changing lanes. Therefore, it is possible to reduce the risk of the lane change by the subject vehicle at approximately the same time as the following vehicle, and to perform the lane change more safely.

According to another example embodiment, a vehicle control device includes: a following vehicle behavior determination unit configured to determine whether a following vehicle, which is a different vehicle in rear of a subject vehicle and traveling in a same lane as the subject vehicle, is about to perform lane change based on a signal from a rear monitoring sensor that outputs information regarding an object existing behind the subject vehicle; and a vehicle controller configured to control automatic lane change of the subject vehicle according to a traffic condition or a traveling schedule set in advance. The vehicle controller cancels or postpones the lane change of the subject vehicle when the following vehicle behavior determination unit determines that the following vehicle is about to perform the lane change in a situation where the subject vehicle is about to perform the lane change.

Also, according to the above configuration, it is possible to reduce the risk of the lane change by the subject vehicle at the approximately same time as the following vehicle. In other words, it is possible to reduce the risk of the lane change by the subject vehicle in a scene where the following vehicle is about to perform the lane change. As the result, it becomes possible to perform the lane change more safely.

Further, according to another example embodiment, a vehicle control method is executed by a vehicle control device mounted on a vehicle, and includes: determining whether a following vehicle, which is a different vehicle in a rear of a subject vehicle and traveling in a same lane as the subject vehicle, is about to perform lane change based on a signal from a rear monitoring sensor that outputs information regarding an object existing behind the subject vehicle; and executing a following vehicle warning process that is a process of notifying a driver that the following vehicle is about to perform the lane change based on determination that the following vehicle is about to perform the lane change.

The above method corresponds to the first vehicle control device, and can obtain the same effects as those of the first vehicle control device by the same action.

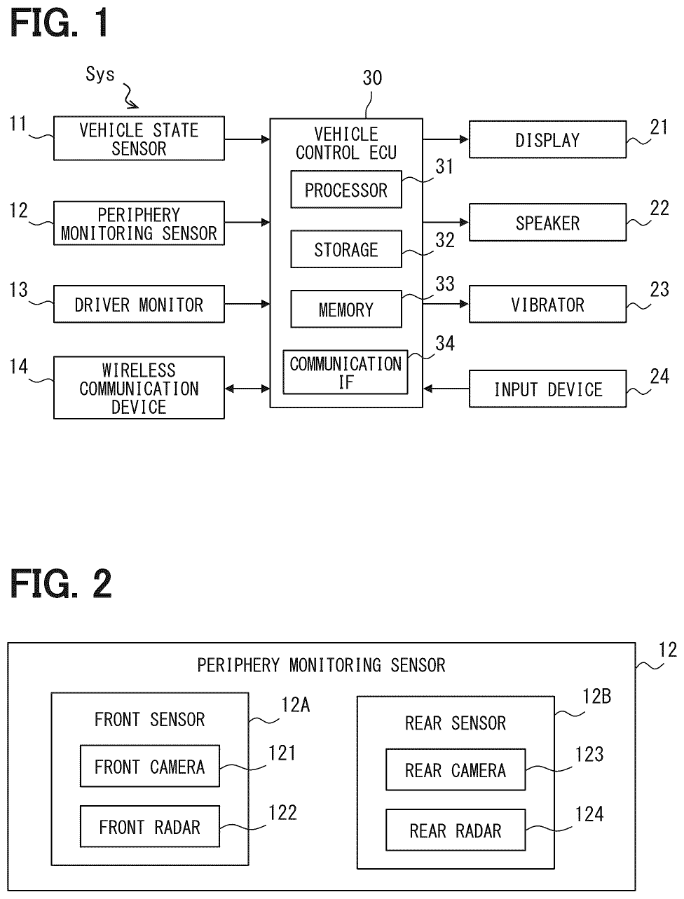

Hereinafter, an embodiment of a vehicle control device and a vehicle control method will be described with reference to the drawings. FIG. 1 is a diagram showing an example of a schematic configuration of an in-vehicle system Sys according to the present embodiment. The present disclosure can be modified as appropriate to comply with the laws, regulations, and customs of a region in which the in-vehicle system Sys described below is used.

### Introduction

The present disclosure is applicable not only to passenger cars but also to a variety of vehicles that can travel on roads, such as tanker trucks and trucks. Hereinafter, a vehicle in which the in-vehicle system Sys is installed will also be referred to as a subject vehicle. The subject vehicle may be an electric vehicle. Here, the subject vehicle may be an engine vehicle. The concept of the electric vehicle may include not only electric vehicles, but also plug-in hybrid vehicles, hybrid vehicles, and fuel cell vehicles. A driver in the present disclosure refers to a person sitting on a driver seat, that is, a driver seat occupant. When the subject vehicle is remotely controlled, a person who remotely controls the subject vehicle (a so-called operator) also corresponds to the driver.

### (Configuration of In-Vehicle System)

As shown in FIG. 1, the in-vehicle system Sys includes a vehicle state sensor 11, a periphery monitoring sensor 12, a driver monitor 13, a wireless communication device 14, a display 21, a speaker 22, a vibrator 23, an input device 24, and a vehicle control ECU 30. The ECU in the member name is an abbreviation for Electronic Control Unit, and means an electronic control device.

The vehicle state sensor 11 is a sensor that detects information related to a state of the vehicle. The vehicle state sensor 11 includes a vehicle speed sensor, a steering angle sensor, a steering sensor, and the like. The vehicle speed sensor detects a travel speed of the subject vehicle. The steering angle sensor detects a steering angle. The steering sensor is a sensor that detects a torque (so-called steering torque) that the driver applies to a steering wheel. The steering sensor may be a sensor that detects the steering angle, which is a rotation angle of the steering wheel.

The vehicle state sensor 11 outputs a signal indicating the current value/state of the item, which is the detection target, to the vehicle control ECU 30. The type of sensor to be provided in the in-vehicle system Sys as the vehicle state sensor 11 may be appropriately designed. The in-vehicle system Sys does not need to include all of the sensors described above. In addition, the in-vehicle system Sys may include sensors other than those described above as the vehicle state sensor 11.

The operation state of a turn signal and the state of the power source for traveling also constitute information regarding the state of the vehicle. The traveling power source is a power supply for travel of the vehicle, and refers to an ignition power source when the vehicle is a combustion engine vehicle. When the vehicle is an electric vehicle or an electric-powered vehicle such as a hybrid vehicle, the power source for traveling refers to a system main relay. Signals indicating the operation state of the turn signal and the state of the traveling power source can also be input to the vehicle control ECU 30. A vehicle speed sensor, a turn signal switch, and the like correspond to an in-vehicle sensor that detects the state of the subject vehicle.

The periphery monitoring sensor 12 is an autonomous sensor that monitors the peripheral environment of the subject vehicle. The periphery monitoring sensor 12 includes a camera that captures images outside the vehicle, a millimeter wave radar, a LIDAR, a sonar, and the like. The periphery monitoring sensor 12 detects predetermined moving and stationary objects within a detection range in a periphery of the subject vehicle, and also detects their positions, movement speeds, and the like.

The LiDAR is an abbreviation for Light Detection and Ranging or Laser Imaging Detection and Ranging. The millimeter wave radar is a device that transmits a probe wave such as a millimeter wave or a quasi-millimeter wave and that detects the relative position and relative speed of an object with respect to the subject vehicle by analyzing reception data of a reflected wave. The reflected wave is the probe wave which is reflected by the object and returned to the millimeter wave radar. The LiDAR is a device that detects objects within a specified detection area based on the results of receiving laser light of a specified wavelength, such as infrared light or near-infrared light.

The in-vehicle system Sys of the present embodiment includes, as the periphery monitoring sensors 12, front sensors 12A that form a detection area in front of the subject vehicle, and rear sensors 12B that form a detection area behind the subject vehicle, as shown in FIG. 2. The expression of “front” includes not only an expression of “straight front” but also an expression of “diagonally front”. The expression of “rear” includes not only an expression of “straight rear” but also an expression of “diagonally rear”.

The in-vehicle system Sys includes a front camera 121 and a front radar 122 as the front sensors 12A. Further, the in-vehicle system Sys also includes a rear camera 123 and a rear radar 124 as the rear sensors 12B. The detection results of the periphery monitoring sensors 12 are input to the vehicle control ECU 30. The rear sensors 12B correspond to a rear monitoring sensor.

The front camera 121 is an optical/infrared camera placed so as to capture an image of the area in front of the vehicle at a predetermined angle of view. For example, the front camera 121 is placed on an upper end portion of a windshield in the vehicle compartment, a front grille, a roof top, or the like. The front camera 121 detects movement objects such as pedestrians and other vehicles by executing a recognition process on image frames. The front camera 121 also detects a lighting state of lighting devices placed on the rear part of a preceding vehicle by analyzing the image. Further, the front camera 121 also detects road markings, road edges, road signs, and the like. The road marking refers to a paint drawn on a road surface for regulation or instruction related to road traffic. For example, the road marking may be referred to as pavement paint. The road marking includes a lane dividing line indicating a lane boundary, a stop line, and a regulatory arrow. The lane marking includes those implemented by a painted white or yellow solid or dashed line, as well as a road stud such as chatter bars or Bott's dots.

The front radar 122 is a millimeter wave radar placed on the front part of the vehicle, such as a front grille or a front bumper. The front radar 122 detects a distance, a relative speed, and a relative position of an object present in the subject vehicle lane, such as a preceding vehicle. In this disclosure, a preceding vehicle refers to a vehicle that is ahead of the subject vehicle, travels in the same lane as the subject vehicle, and is closest to the subject vehicle. The following vehicle refers to the vehicle that is present behind the subject vehicle, travels in the same lane as the subject vehicle, and is the closest vehicle to the subject vehicle. In the present disclosure, the lane in which the subject vehicle is traveling among the lanes of the road on which the subject vehicle is traveling is referred to as a subject vehicle lane. The subject vehicle lane may also be called an ego lane.

The rear camera 123 is an optical/infrared camera placed so as to capture an image of an area in rear of the vehicle at a predetermined angle of view. The rear camera 123 is placed at an arbitrary position on the rear side of the vehicle, such as near the upper end of the rear window. The rear camera 123 detects a mobile object, the road markings, a road edge, and the like by executing the recognition process on the image frames. The mobile object, which is the detection target, may include the following vehicle. In addition, the rear camera 123 detects an operation state of the turn signal of the following vehicle by analyzing the image. The rear radar 124 is a millimeter wave radar placed on a rear bumper. The rear radar 124 detects the relative positions and relative speeds of other vehicles present behind the subject vehicle, following vehicles, and the like.

The above-described periphery monitoring sensors 12 are merely examples, and the in-vehicle system Sys does not need to include all of the periphery monitoring sensors 12 described above. The in-vehicle system Sys may also include side cameras that capture images of the side areas of the vehicle. The side cameras are placed on the left and right side mirrors. The side cameras also analyze the images and generate signals indicating the behavior of other vehicles to the side. The traffic conditions behind the vehicle may be obtained by analyzing images captured by the side cameras.

The function of detecting the behavior of other vehicles by analyzing the camera image may be provided by an external device of the camera or the vehicle control ECU 30. In this case, each camera serving as a periphery monitoring sensor outputs a video signal to the vehicle control ECU 30. The video signal itself from a camera capturing an image outside the vehicle can also correspond to a signal indicating the behavior of other vehicles.

The driver monitor 13 is a sensor that includes a camera arranged to capture an image of the driver and detects the state of the driver by analyzing the image from the camera. The driver monitor 13 is placed on an upper surface of a steering column cover, an upper surface of an instrument panel, the upper end of the windshield, or the like, with its optical axis directed toward a headrest of a driver seat. The camera provided in the driver monitor 13 may be a visible light camera or an infrared camera.

The driver monitor 13 successively detects the driver state based on the facial image of the driver included in the capture image. The driver monitor 13 sequentially detects the driver state, such as a direction of a driver face, a direction of the driver line of sight, and a degree to which driver eyelids are open (so-called eye opening degree). The driver monitor 13 sequentially outputs information indicating the state of the driver identified from the capture image to the vehicle control ECU 30 as driver state data. The vehicle control ECU 30 may have the function of detecting the state of the driver, and the like by analyzing the video signal from the camera. The driver monitor 13 also corresponds to an in-vehicle sensor that detects the driver behavior.

The wireless communication device 14 is a device for performing the wireless communication between the subject vehicle and other devices. The wireless communication device 14 is capable of performing cellular communication. The cellular communication is wireless communication that complies with standards such as LTE (i.e., Long Term Evolution), 4G, and 5G. The wireless communication device 14 may be configured to perform cellular V2X (e.g., PC5/Uu) communication.

Moreover, the wireless communication device 14 is able to perform short range communication. In present embodiments, the short-range communication refers to wireless communication in which the communication distance is limited to within several hundred meters. As a standard for the short range communication, it is possible to adopt DSRC (Dedicated Short Range Communications) corresponding to the IEEE802.11p standard, Wi-Fi (registered trademark), or the like. The dedicated short-range communication may be implemented by the above-described cellular V2X. The short-range communication with other vehicles is also called inter-vehicle communication. The wireless communication device 14 may be capable of performing only one of the cellular communication or the short range communication.

The wireless communication device 14 can obtain dynamic map data corresponding to the current location from an external device such as a map distribution server or a roadside device. The dynamic map data is map data that indicates positions of obstacles on the road, and the like. The obstacles include parked vehicles, construction areas, lane restriction areas, and fallen objects. The wireless communication device 14 can receive vehicle information from the preceding vehicle and the following vehicle through the inter-vehicle communication. The vehicle information may include an illumination state of hazard lights, vehicle speed, turn signal operation status, steering angle, and the like. The data received by the wireless communication device 14 is transmitted to the vehicle control ECU 30.

The display 21 is a device for displaying images. The in-vehicle system Sys includes, as the display 21, one or more of a head-up display (HUD), a meter display, and a center display. The HUD is a device that projects image light onto a predetermined area of the windshield, thereby displaying an image at a position that overlaps with the view ahead. The meter display is a display placed at an area of the instrument panel in front of the driver seat. The center display is, for example, a display placed in the central region of the instrument panel. The meter display and the center display can be implemented using a liquid crystal display or an organic EL display. Based on the control signal and the image signal input from the vehicle control ECU 30, the display 21 displays an image corresponding to input signals.

The speaker 22 is a device that outputs a sound corresponding to a signal input from the vehicle control ECU 30. The expression of “sound” includes voice, music, and the like in addition to a notification sound. The vibrator 23 is a device for applying vibration stimulation to the driver, and is provided on the steering wheel or the backrest of the driver seat. The vibrator 23 may be disposed at a plurality of locations. The vibrator 23 may be a device that applies a vibration stimulus to the driver by vibrating a seat belt itself.

The in-vehicle system Sys may include an ambient light or the like as an informing device. The ambient light is lighting devices that use a plurality of light emitting diodes (i.e., LEDs) and that are capable of adjusting the emission color and the emission intensity of light, and are provided on an instrument panel, a steering wheel, and the like. In addition, the vehicle control ECU 30 may be configured to be able to execute control for tightening the seat belt of the driver seat by a predetermined amount. The tightening of the seat belt can also be used as stimulation to alert the driver.

The input device 24 is a device for receiving an instruction operation from the driver to the in-vehicle system Sys. The input device 24 may be a steering switch provided on the spokes of the steering wheel, a touch panel stacked on the center display, or the like. The in-vehicle system Sys may be equipped with a plurality of types of devices as the input device 24. An operation member for operating the turn signal, a so-called turn signal lever/switch, may also be included in the input device 24. Further, the input device 24 may also include a device for voice input such as a microphone.

The input device 24 outputs an electrical signal corresponding to an operation by the driver to the vehicle control ECU 30 as an operation signal. The display 21, speaker 22, vibrator 23, and input device 24 constitute an in-vehicle HMI (Human Machine Interface). An HCU (HMI Control Unit) may be interposed between the various devices constituting the in-vehicle HMI and the vehicle control ECU 30. The HCU is a device that comprehensively controls the notification of information to the driver.

The vehicle control ECU 30 is an ECU that controls the presentation of information to the driver regarding lane changes and the like. The vehicle control ECU 30 may be able to perform vehicle control such as ACC (Adaptive Cruise Control). The ACC refers to a control function that causes the subject vehicle to travel at a constant speed at a predetermined target speed when there is no preceding vehicle within a predetermined distance, and causes the vehicle to follow the preceding vehicle while maintaining a safe distance from a preceding vehicle when there is the preceding vehicle within the predetermined distance. The ACC starts based on occupant instructions. The ACC target speed may be input by the driver, or a speed limit determined by map data or road sign recognition may be applied.

The vehicle control ECU 30 mainly includes a computer including a processor 31, a storage 32, a memory 33, a communication interface 34, and a bus connecting these components. The processor 31 is an arithmetic core such as a CPU (Central Processing Unit) or a GPU (Graphics Processing Unit). The processor 31 accesses the memory 33 to execute various processes. The storage 32 is a rewritable non-volatile memory such as a flash memory. The storage 32 stores a vehicle control program, which is a program for causing a normal computer to function as the vehicle control ECU 30. The vehicle control program includes a notification control program for controlling the presentation of information to the occupant. The execution of the vehicle control program by the processor 31 corresponds to the execution of a vehicle control method. The memory 33 is a rewritable volatile storage medium, and is a RAM (i.e., Random Access Memory). The vehicle control ECU 30 corresponds to a vehicle control device.

### (Functions of Vehicle Control ECU)

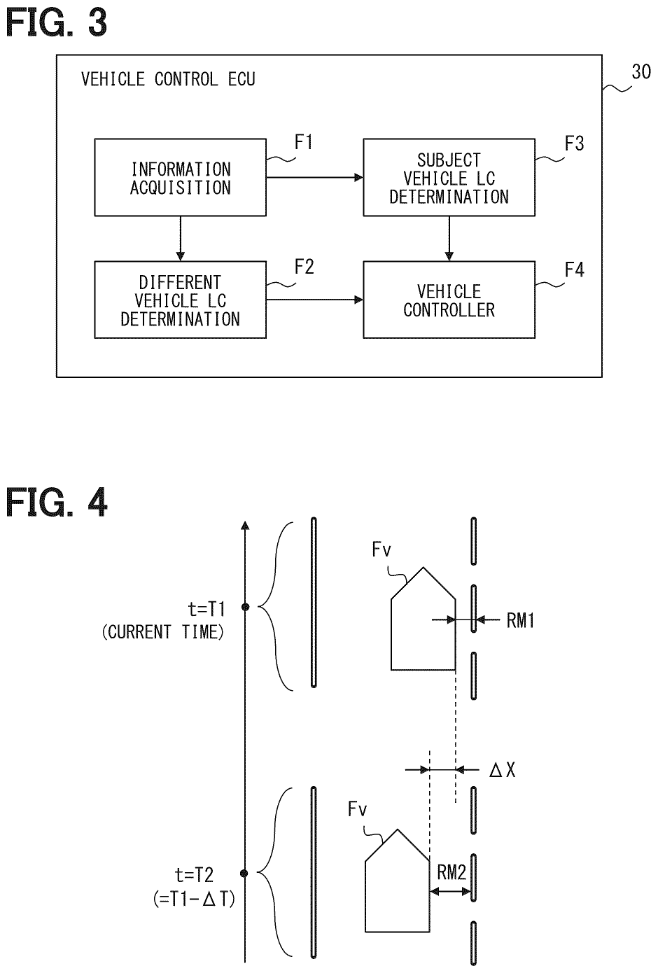

As shown in FIG. 3, the vehicle control ECU 30 includes, as functional units, an information acquisition unit F1, a different vehicle LC determination unit F2, a subject vehicle LC determination unit F3, and a vehicle controller F4. These functional units are implemented by the processor 31 executing a vehicle control program. In addition, in this disclosure, the term “LC” means lane change. The term “LC determination unit” can be read as “lane change determination unit.”

The information acquisition unit F1 acquires various information from the vehicle state sensor 11 and the like, and temporarily stores the information in the memory 33. The information acquisition unit F1 acquires information such as the travel speed of the subject vehicle, acceleration, steering state, and turn signal operation state from the vehicle state sensor 11. Further, the information acquisition unit F1 also acquires detection results from the periphery monitoring sensor 12. The information acquisition unit F1 acquires information such as the relative speeds and relative positions of the preceding and following vehicles, the operation state of the turn signals, and the lighting status of the brake lights/hazard lights. Further, the information acquisition unit F1 acquires the positions of lane section lines on the left and right of the subject vehicle, the positions of road edges, and the like. Position information of other vehicles, lane markings, and the like may be expressed in a two-dimensional or three-dimensional relative coordinate system with respect to the subject vehicle.

The information acquisition unit F1 can acquire the position, speed, acceleration, and turn signal operation state of the following vehicle based on an image from the rear camera 123 or a signal received through the inter-vehicle communication. Furthermore, the information acquisition unit F1 acquires position information of obstacles present in the subject vehicle lane, based on the detection results of the front sensors 12A and obstacle information distributed from an external device.

The information acquisition unit F1 identifies the lateral position of the subject vehicle relative to the subject vehicle lane based on signals from the front camera 121 and the rear camera 123. The lateral position is the relative position with respect to the lane markings, in other words, the offset amount with respect to the center of the lane. The lateral position indicates whether the vehicle is traveling in the center of the lane, close to one side, straddling a lane marking, and the like. The horizontal position can be expressed by at least one of three parameters: a right margin, a left margin, or a center offset. The right margin indicates the distance from the right lane marking, which is the right one of the two lane markings that define the subject vehicle lane, to the right edge of the subject vehicle. The left margin indicates the distance from the left lane marking, which is the left one of the two lane markings that define the subject vehicle lane, to the left edge of the subject vehicle. The center offset amount indicates the position of the center of the subject vehicle relative to the lane center line located halfway between the right and left lane markings. The center offset is equal to half the difference between the right and left margins. The lateral position may be determined using distance information from the edge of the road or from a traffic control arrow.

The information acquisition unit F1 acquires the lateral position of the following vehicle by combining the lane markings and the position information of the following vehicle. The “acquisition” in the present embodiment includes generation and detection by internal calculation based on data or the like received from another device and/or another sensor. The lateral position of the following vehicle, in other words, its position relative to the lane markings, may be determined by analyzing the image from the rear camera 123. The time-series data on the lateral position of the following vehicle functions as information for determining whether the following vehicle is wobbling or is about to change lanes. The time-series data refers to data in which observed values at a plurality of points in time are arranged in order of observation time.

Additionally, the information acquisition unit F1 acquires information indicating the state/behavior of the driver from the driver monitor 13. The information indicating the state of the occupant includes the direction of the face, the direction of the line of sight, the posture, and the degree of opening of the eyes. The direction of the light of sight indicates whether the driver is looking toward the side mirror, rear-view mirror, or to the side or diagonally backward.

The various information successively acquired by the information acquisition unit F1 are stored in a temporary storage medium such as the memory 33, and are used by the different vehicle LC determination unit F2, the subject vehicle LC determination unit F3, the vehicle controller F4, and the like. The various information can be classified by types and stored in the memory. For example, the various information can be sorted and stored with the latest data first. The data in which a certain time elapses after acquisition can be discarded from the memory.

The different vehicle LC determination unit F2 determines whether the following vehicle is about to change lanes, based on various information acquired by the information acquisition unit F1. In other words, the different vehicle LC determination unit F2 detects a sign of a lane change in the following vehicle. The different vehicle LC determination unit F2 corresponds to a following vehicle behavior determination unit. The different vehicle LC determination unit F2 can also be called a different vehicle behavior determination unit.

The different vehicle LC determination unit F2 determines that the following vehicle is about to change lanes when the right or left turn signal of the following vehicle is operating (flashing). The operation of the turn signal of the following vehicle may be detected by analyzing the image from the rear camera 123, or may be determined based on a signal received from the following vehicle via the inter-vehicle communication.

In addition, when the different vehicle LC determination unit F2 determines that the following vehicle is about to change lanes, it obtains the LC direction, which is the direction in which the following vehicle is about to change lanes, based on which of the left and right lamps is on. The LC direction can also be identified by analyzing the image from the rear camera 123. In addition, the different vehicle LC determination unit F2 may specify the LC direction based on a signal received through the inter-vehicle communication.

As another aspect, the different vehicle LC determination unit F2 may detect that the following vehicle is about to change lanes based on time-series data of the lateral position of the following vehicle. As shown in FIG. 4, the different vehicle LC determination unit F2 may detect that the following vehicle is about to change lanes based on a lateral position variation amount (ΔX) that indicates the amount of change in the lateral position of the following vehicle between the current time and a predetermined time ago. The lateral position change amount may be a value obtained by subtracting a right margin (RM2) of the following vehicle at a previous time (t=T2) from the right margin (RM1) of the following vehicle at the current time (t=T1). FIG. 4 shows a scene in which the following vehicle is about to move into the right lane. In the figure, Fv indicates the following vehicle.

The past lateral position information of the following vehicle used to calculate the lateral position change amount may be an observation value from one second ago, two seconds ago, or three seconds ago. That is, ΔT in FIG. 4 is set to a value of about several seconds. The different vehicle LC determination unit F2 determines that the following vehicle is about to change lanes based on the absolute value of the lateral position variation amount, ΔX (=RM1−RM2), being equal to or greater than a predetermined value. The LC direction can be determined based on the sign of the lateral position change amount. When ΔX=RM1−RM2 is used as the calculation equation for calculating the lateral position change amount, a negative lateral position variation amount indicates that the LC direction is to the right, and a positive lateral position change amount indicates that the LC direction is to the left.

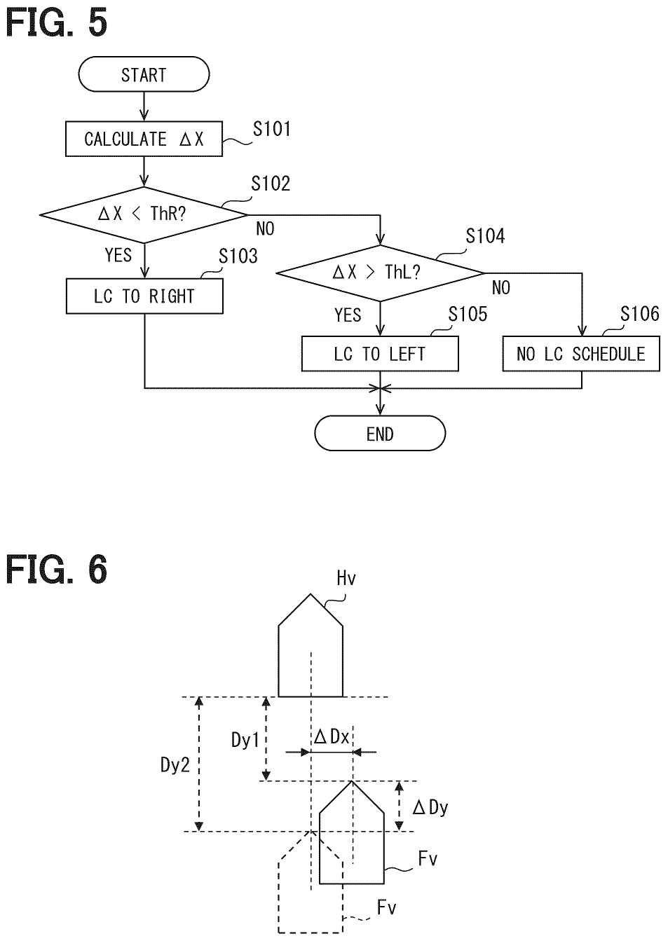

FIG. 5 is a flowchart showing an example of the operation of the different vehicle LC determination unit F2. The flowchart shown in FIG. 5 can be executed at a predetermined interval when the following vehicle is detected. S101 in FIG. 5 is a process of acquiring the right margin of the following vehicle and calculating the lateral position variation amount of the following vehicle. When the lateral position change amount is less than the right LC determination value (YES in S102), the different vehicle LC determination unit F2 determines that the following vehicle is about to move to the right lane (S103). ThR in FIG. 5 indicates the right LC determination value, and is set to a value corresponding to, for example, −0.5 meters (m) or −0.75 meters. S102 corresponds to a process of determining whether ΔX<ThR is satisfied.

Further, when the observed lateral position change amount is greater than the left LC determination value (YES in S104), it is determined that the following vehicle is about to move into the left lane (S105). In the figure, ThL indicates the left LC determination value, and is set to a value corresponding to, for example, +0.5 m or +0.75 m. S104 corresponds to a process of determining whether ΔX>ThL is satisfied.

Then, when the lateral position change amount is greater than or equal to the right LC determination value and less than or equal to the left LC determination value (NO in S104), the different vehicle LC determination unit F2 determines that the following vehicle has no schedule to change lanes/execution possibility of the lane change is low, and ends this flow (S106).

In the above, the different vehicle LC determination unit F2 calculates the lateral position change amount using the right margin. However, the different vehicle LC determination unit F2 may calculate the lateral position variation amount using the left margin or the center offset amount. Signs and magnitudes of the right LC determination value and the left LC determination value can be changed depending on the parameters used to calculate the lateral position change amount, a setting of the coordinate system, and the configuration of a subtraction expression. The above configuration corresponds to a configuration for determining whether the following vehicle is about to change lanes based on a change over time in the relative position of the following vehicle with respect to the lane marking.

As yet another aspect, the different vehicle LC determination unit F2 may determine whether the following vehicle is about to change lanes based on a change over time in the relative position of the following vehicle with respect to the subject vehicle. The different vehicle LC determination unit F2 may determine whether the following vehicle is attempting to change lanes based on a lateral distance (Dx1) at time T1 and a lateral distance (Dx2) at time T2, as shown in FIG. 6. Specifically, it may be determined that the following vehicle is about to change lanes based on whether Dx2−Dx1=ΔDx is equal to or greater than a predetermined value. Also, when overtaking, the following vehicle accelerates and moves into the adjacent lane. Therefore, when the following vehicle is attempting to overtake the subject vehicle, the distance in the longitudinal direction (the so-called inter-vehicle distance) may also become small. Therefore, the different vehicle LC determination unit F2 may determine that the following vehicle is about to change lanes not only when ΔDx is greater than or equal to a predetermined value, but also when Dy2−Dy1=ΔDy is greater than or equal to a predetermined value (for example, +2 m). The ΔDy determined by the above equation indicates the amount by which the following vehicle approaches the subject vehicle. In the figure, Hv indicates the subject vehicle itself.

Alternatively, the different vehicle LC determination unit F2 may determine that the following vehicle is about to change lanes based on detecting that the following vehicle is wobbling. The wobbling state of the following vehicle corresponds to a state where the lateral position of the following vehicle repeatedly increases and decreases. The different vehicle LC determination unit F2 can determine that the following vehicle is about to change lanes based on whether the time series data of the lateral position of the following vehicle corresponds to a predetermined pattern registered as a sign of a lane change. The pattern indicating a lane change is, for example, a pattern in which the value indicating the lateral position increases/decreases at a predetermined speed, or a pattern in which the value repeatedly increases/decreases with an amplitude equal to or greater than a predetermined value.

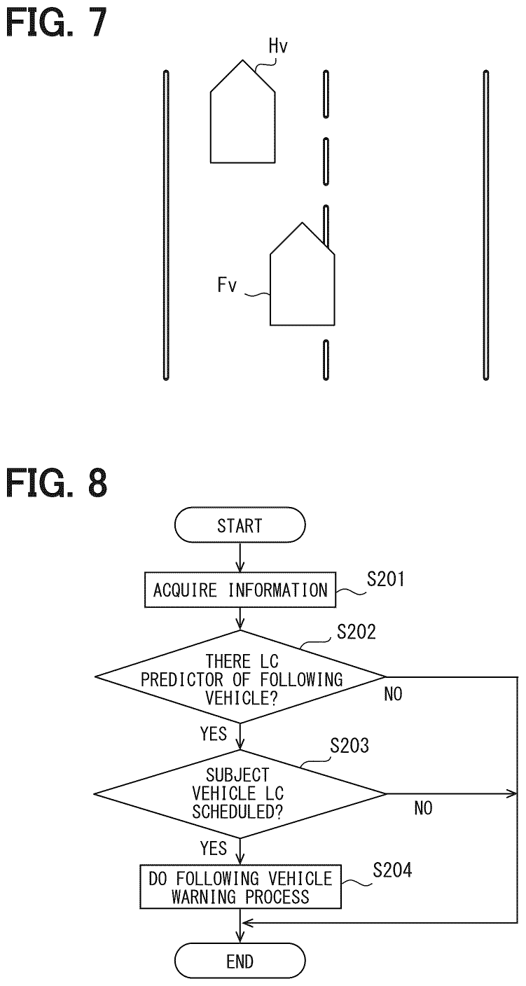

Also, the different vehicle LC determination unit F2 may determine that the following vehicle is about to change lanes based on the state where the following vehicle has crossed over into another lane, as shown in FIG. 7. It is possible to identify whether the following vehicle is crossing a lane marking by analyzing the image from the rear camera 123. The state of crossing a lane marking means that a part of the vehicle body (for example, tires) is on the lane marking. The different vehicle LC determination unit F2 may determine whether the following vehicle is about to change lanes when the following vehicle is approaching the subject vehicle at a relative speed equal to or greater than a predetermined value and the distance between the following vehicle and the subject vehicle is less than a predetermined value. The camera that the different vehicle LC determination unit F2 uses to detect the behavior of the following vehicle may be a side camera. Furthermore, when the front camera 121 detects an obstacle on the subject vehicle lane, it may also be determined that the following vehicle is about to change lanes. In this scene, although the subject vehicle changes lanes, the following vehicle will also have to change lanes. The different vehicle LC determination unit F2 may determine whether the following vehicle is about to change lanes by combining the various determination factors described above.

The subject vehicle LC determination unit F3 is configured to determine whether the subject vehicle is about to change lanes. The state in which the subject vehicle is about to change lanes is not limited to a state in which the driver is about to change lanes, but also includes a state in which the system is about to automatically change lanes. The subject vehicle LC determination unit F3 corresponds to a subject vehicle behavior determination unit.

The subject vehicle LC determination unit F3 may determine that the subject vehicle is about to change lanes when the turn signal of the subject vehicle is operating. In addition, the subject vehicle LC determination unit F3 may determine whether a lane change is required based on the traveling schedule route of the subject vehicle, periphery map information, and the current subject vehicle lane number. Determining that a lane change is necessary corresponds to determining that the subject vehicle is about to change lanes.

Whether the lane change is necessary can be determined based on the relationship between the traveling direction assigned to the subject vehicle lane and the traveling schedule route. A situation in which the lane change is necessary corresponds to a situation where the current subject vehicle lane is a lane reserved for left or right turns although the subject vehicle is scheduled to go straight through the intersection. Similarly, the situation in which the lane change is necessary corresponds to a situation where the current subject vehicle lane is a lane dedicated for straight traveling although the subject vehicle is scheduled to turn right/left at the intersection. Situations where lane changes are necessary include when merging from an acceleration lane onto a main highway or when moving from a main highway onto a branching road. The traveling schedule route and the periphery map information can be obtained from various devices such as a navigation device, a locator, and an automated driving device mounted on the subject vehicle.

Additionally, a situation in which the lane change is necessary also corresponds to a situation where the obstacle is present within a predetermined distance ahead of the subject vehicle lane. In other words, when it is detected that there is an obstacle on the subject vehicle lane, it may be determined that the subject vehicle is about to change lanes. The presence or absence of an obstacle may be detected by the front sensor 12A, or may be received from a roadside unit or an external server. It may be determined that the subject vehicle itself will also change lanes when the preceding vehicle has changed lanes.

Furthermore, the subject vehicle LC determination unit F3 may determine that the subject vehicle is about to change lanes when it detects that the driver has performed an action of checking the rear. The action of checking the rear refers to an action of looking at the side mirror/rear-view mirror or turning your head to the rear area. These actions can be detected based on signals from the driver monitor 13. The in-vehicle system Sys may be configured to display an image from the rear camera 123 or the side camera on the display 21 configured to display the image, based on the driver operation on the input device 24. In such a configuration, when the vehicle speed is above a predetermined value, it may be determined that the subject vehicle is about to change lanes based on an operation signal input from the input device 24 to display the image from the rear camera 123 or the side camera on the display 21.

The subject vehicle LC determination unit F3 may determine that the subject vehicle is about to change lanes when the subject vehicle is approaching the preceding vehicle at a relative speed equal to or greater than a predetermined value and the distance between the subject vehicle and the preceding vehicle is less than a predetermined value. Also, it may be determined that the subject vehicle is about to change lanes when the speed of the preceding vehicle is slower than an ACC target speed set for the subject vehicle.

When determining whether the subject vehicle or a following vehicle is about to change lanes, the traffic conditions of the target lane, which is the adjacent lane to which the subject vehicle moves, may be taken into consideration. The processor 31 may determine that no lane change is scheduled when an empty space of a predetermined size or larger is not detected on the target lane. In other words, the different vehicle LC determination unit F2 and the subject vehicle LC determination unit F3 may determine that the following vehicle or the subject vehicle is about to change lanes on a condition that there is an available space on the target lane.

The vehicle controller F4 executes a following vehicle warning process based on the determination result of the different vehicle LC determination unit F2. The following vehicle warning process is a process for notifying the driver that the following vehicle is about to change lanes. The vehicle controller F4 executes the following vehicle warning process when the subject vehicle LC determination unit F3 determines that the subject vehicle is about to change lanes and the different vehicle LC determination unit F2 determines that the following vehicle is also about to change lanes.

In the following vehicle warning process, the vehicle controller F4 displays an icon at a predetermined position on the display 21, the icon indicating that the following vehicle is about to change lanes. The icon may include an arrow indicating the LC direction of the following vehicle. The image displayed as part of the following vehicle warning process may be changed depending on the LC direction of the following vehicle. The following vehicle warning process may be a process of turning on a predetermined indicator. The following vehicle warning process may be a process of displaying an icon image on a side mirror or turning on an indicator.

As part of the following vehicle warning process, the vehicle controller F4 may display on the display 21 a notification image, which is a computer graphics (CG) image indicating that the following vehicle is about to change lanes. The CG is also called CGI (Computer Generated Imagery). The notification image displayed by the vehicle controller F4 as the following vehicle warning process may be a 2D/3D animation image of the following vehicle turning on its blinker. The image of the following vehicle included in the notification image is a predetermined 3D model and is not based on an actual camera image. However, the image of the following vehicle included in the notification image may be a 3D model that imitates the actual following vehicle. In order to improve the driver recognition, the color and shape (model) of the following vehicle in the notification image may be dynamically set to a color and shape that is highly similar to that of the actual following vehicle captured by the rear camera 123. The notification image may be an overhead image looking down on the subject vehicle and the following vehicle from a virtual viewpoint placed in the air in front of the subject vehicle. Of course, the notification image may be an image of a following vehicle operating its turn signal as seen through the rear window. The notification image may be an animated image showing a following vehicle attempting to overtake the subject vehicle. The viewpoint and expression method of the notification video can be changed as appropriate.

The vehicle controller F4 may output a notification sound (warning sound) of a predetermined pattern or a voice message from the speaker 22 as the following vehicle warning process. Further, the vehicle controller F4 may vibrate the vibrator 23 provided on the steering wheel, the seat belt, the backrest of the driver seat, and the like in a predetermined pattern as the following vehicle warning process. The configuration in which the backrest of the driver seat is vibrated makes it easier for the driver to intuitively recognize that the driver should be careful of the area behind the vehicle. The vehicle controller F4 may execute control to wind up (tighten) the seat belt by a predetermined amount as the following vehicle warning process. The vehicle controller F4 may execute the following vehicle warning process by appropriately combining actions with different types of stimulation, such as image display, sound output, and vibration generation.

The vehicle controller F4 is not limited to the following vehicle warning process, but can also execute control processes such as ACC. Additionally, information related to ACC may be presented to the driver as appropriate. However, the relevant function of the ACC is an optional element. The vehicle control ECU 30 itself does not need to have a function such as ACC.

### (Operation of Vehicle Control ECU)

Here, the operation of the vehicle control ECU 30 will be described with reference to a flowchart shown in FIG. 8. The flowchart shown in FIG. 8 is executed periodically at a predetermined cycle, such as every 200 milliseconds, 500 milliseconds, or 1 second, while a traveling power supply for the subject vehicle is on or while a shift position is set to a position that allows forward movement (for example, D/S). A flowchart shown in FIG. 8 includes processes S201 to S204 as an example. Each process is executed in sequence according to the arrows shown in FIG. 8. The description of the processor 31 as the entity that executes the processes can be interpreted as any one of a plurality of functional units that the vehicle control ECU 30 has, such as the information acquisition unit F1 to the vehicle controller F4, as appropriate.

A process in S201 is a process in which the processor 31 obtains various information to be used in the subsequent process. The information acquisition unit F1 can acquire a subject vehicle speed, an operation state of the turn signal, a traffic condition ahead of the subject vehicle, the driver line of sight, the behavior of the following vehicle, and the like.

A process in S102 is a process in which the processor 31 determines whether the following vehicle is about to change lanes. As described above, there are various methods for determining whether the following vehicle is about to change lanes. When it is determined that the following vehicle is attempting to change lanes (YES in S202), the processor 31 executes a process in S203. On the other hand, when no behavior suggesting the lane change is observed from the following vehicle (NO in S202), this flow ends.

A process in S203 is a process in which the processor 31 determines whether the subject vehicle is about to change lanes. As described above, various conditions can be adopted as the conditions for determining that the subject vehicle is about to change lanes. When the subject vehicle is about to change lanes (YES in S203), the processor 31 executes a process in S204. On the other hand, when a condition for determining that the subject vehicle is about to change lanes is not satisfied (NO in S203), this flow ends.

In a process in S204, the processor 31 cooperates with an alarm device such as the display 21 to carry out a following vehicle warning process. The processor 31 may display a notification image on the display 21 and sequentially output a signal for vibrating the vibrator 23 provided on the steering wheel.

### Difficulties and Effects

In an actual traffic situation, at a time same as or earlier than a time when the subject vehicle is about to change the lane to the overtaking lane, the following vehicle may also be about to change lanes in the same direction. As the result, the following vehicle and the subject vehicle may become excessively close to each other. The following vehicle also tends to pay more attention to the target lane than to the front area. In such an event, in a configuration in which the warning is issued based on the relative positions of the subject vehicle and other vehicles traveling in the target lane, the warning may be delayed or not issued at all when the vehicle and the following vehicle are about to change lanes at approximately the same time, as described above.

To address such a difficulty, the configuration of the present disclosure notifies the driver of the attempt to change lanes upon detection that the following vehicle is about to change lanes. Therefore, the driver becomes easier to recognize the state where the following vehicle is about to change lanes. As a result, it is expected that the system will be able to respond in a way that improves safety, such as canceling or postponing a lane change by the subject vehicle. Postponing the lane change corresponds to putting it on hold temporarily.

Further, when the subject vehicle is not considering changing lanes, whether the following vehicle is going to change lanes is not particularly important information. Therefore, when the driver is notified of the lane change by the following vehicle without the lane change schedule of the subject vehicle, this notification may cause inconvenience to the driver. To address such a difficulty, the vehicle control ECU 30 of the above embodiment notifies the following vehicle of the lane change on the condition that the subject vehicle is about to change lanes. In other words, when it is determined that the subject vehicle is not about to change lanes, no notification regarding the lane change of the following vehicle is provided. Therefore, according to the above embodiment, it is possible to reduce the risk of causing inconvenience to the occupants. The state in which the subject vehicle is about to change lanes corresponds to an example of a specific state.

In addition, the above configuration has the advantage that the driver can easily recognize the presence of the following vehicle approaching the subject vehicle at an approaching speed equal to or greater than a predetermined value. When the subject vehicle lane is an overtaking lane, such as the second lane, the driver will be more likely to respond by moving to the first lane (traveling lane) in response to the following vehicle warning process.

While the embodiment of the present disclosure has been described above, the present disclosure is not limited to the embodiment described above, and various modifications to be described below are included in the technical scope of the present disclosure and may be implemented by various modifications within a scope not departing from the spirit of the present disclosure, in addition to the modifications to be described below. Various supplements, modifications, and the like described below can be appropriately combined and implemented within a range in which no technical contradiction occurs. Components having the same or equivalent functions as those of the components described above are denoted by the same reference symbols, and description thereof may be omitted. When only a part of the configuration is mentioned, the description in the above embodiment can be applied to the remaining parts.

### (First Modification)

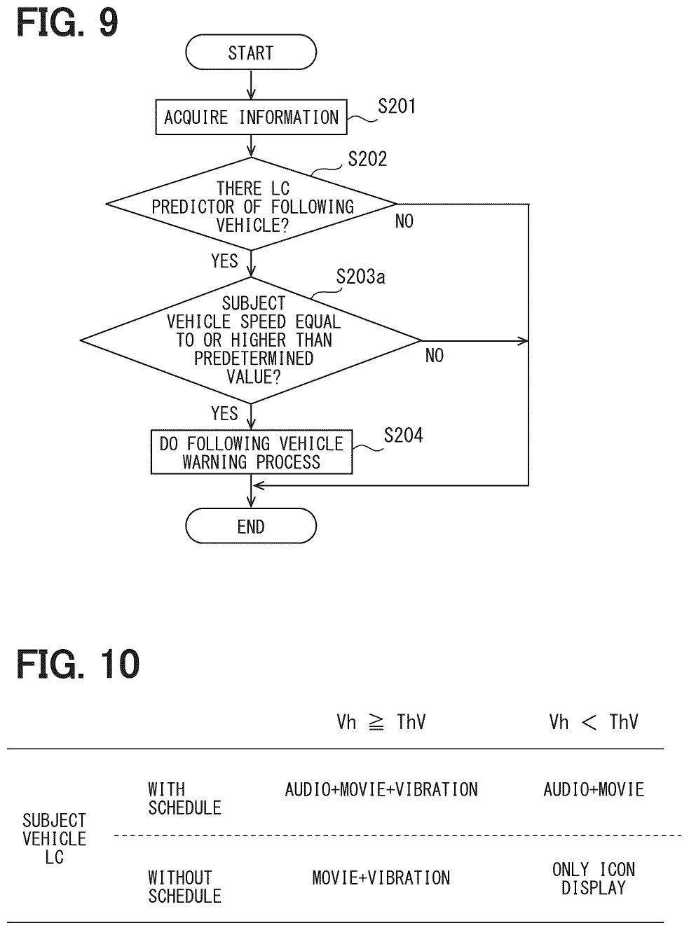

The following vehicle warning process is not limited to a situation in which the subject vehicle is about to change lanes. The subject vehicle LC determination unit F3 is an optional element and may be omitted. As shown in FIG. 9, the processor 31 may execute following vehicle warning process on the condition that the subject vehicle speed is equal to or greater than a predetermined notification threshold (S203a), regardless of whether the subject vehicle is scheduling the lane change (LC). A state in which the subject vehicle speed is equal to or greater than a notification threshold also corresponds to an example of the specific state. The notification threshold may be set to a value such as 50 km/h or 60 km/h, which indicates that traffic is flowing, or that the vehicle is traveling on an automobile road. Of course, the notification threshold may be 30 km/h, 0 km/h, or the like.

According to the above configuration, it is possible to simplify the process of the vehicle control ECU 30, and reduce the process load of the processor 31. Further, according to this modification, the conditions for implementing the following vehicle warning process are relaxed compared to the configuration disclosed as the embodiment, so that the driver can more easily recognize the movement of the following vehicle.

Furthermore, in the above embodiment, although the subject vehicle is actually about to change lanes, erroneous determination that the subject vehicle is not about to change lanes is performed, and the execution possibility of the following vehicle warning process does not become zero. According to this modification, it is possible to reduce the risk that the following vehicle warning process does not operate in a scene in which the behavior of the following vehicle should be notified based on an erroneous determination of the movement of the subject vehicle regarding the lane change.

Setting the notification threshold to 0 km/h corresponds to removing the speed condition for executing the following vehicle warning process. According to such a setting mode, in a situation where only the subject vehicle lane is congested and the adjacent lane is clear, the driver can be notified of the behavior of the following vehicle even when the subject vehicle and the following vehicle attempt to move into the adjacent lane at the same time.

### (Second Modification)

The processor 31 may change whether to provide notification and the notification mode depending on the state of the subject vehicle when it detects that the following vehicle is about to change lanes. In other words, when detecting that the following vehicle is about to change lanes, the processor 31 may divide the state of the subject vehicle into a plurality of state patterns, and change the manner of the following vehicle warning process for each state pattern.

FIG. 10 shows an example of this control. In other words, when it is determined that the subject vehicle is about to change lanes and the vehicle speed is equal to or higher than the notification threshold, the driver is notified of the behavior of the following vehicle by emitting a notification sound, displaying a notification image, and applying vibrations. On the other hand, when it is determined that the subject vehicle is about to change lanes and the vehicle speed is lower than the notification threshold, a notification sound and notification image are used to alert the driver to the behavior of the following vehicle. This configuration corresponds to a mode in which the magnitude of the warning is weakened based on a state where the vehicle speed is equal to or lower than a predetermined value.

In addition, in the example shown in FIG. 10, when the processor 31 does not determine that the subject vehicle is about to change lanes and the vehicle speed is equal to or greater than the notification threshold, the processor 31 provides notification about the behavior of the following vehicle using only notification images and vibration. Further, when it is not determined that the subject vehicle is about to change lanes and the vehicle speed is less than the notification threshold, an icon image indicating the behavior of the following vehicle is simply displayed at a specified position on the display 21.

According to the above control mode, the behavior of the following vehicle is notified with a level of intensity that corresponds to the certainty that the subject vehicle is about to change lanes. Therefore, it is possible to further reduce the risk of causing discomfort to the driver. In addition, Vh in FIG. 10 indicates the traveling speed of the subject vehicle, and ThV indicates the notification threshold.

### (Third Modification)

The vehicle control ECU 30 may be a device that automatically performs lane changes depending on the traffic conditions ahead of the subject vehicle or in accordance with a preset traveling schedule. The vehicle control ECU 30 can create a lane change control schedule in order to overtake a slow vehicle ahead or to implement a preset traveling route, and can automatically execute lane changes with the driver approval. In addition, cases where the driver approval has been obtained includes case where, as vehicle operation settings, permission for execution of the automatic lane change based on the system determination is registered.

The vehicle control ECU 30 having the function of automatically performing the lane change can also be considered as an automated driving device or an advanced driving assistance device. The automatic lane change can be performed after confirming, based on the detection results of the periphery monitoring sensor 12, that there is a predetermined size of free space in the target lane, which is the adjacent lane to which the vehicle moves.

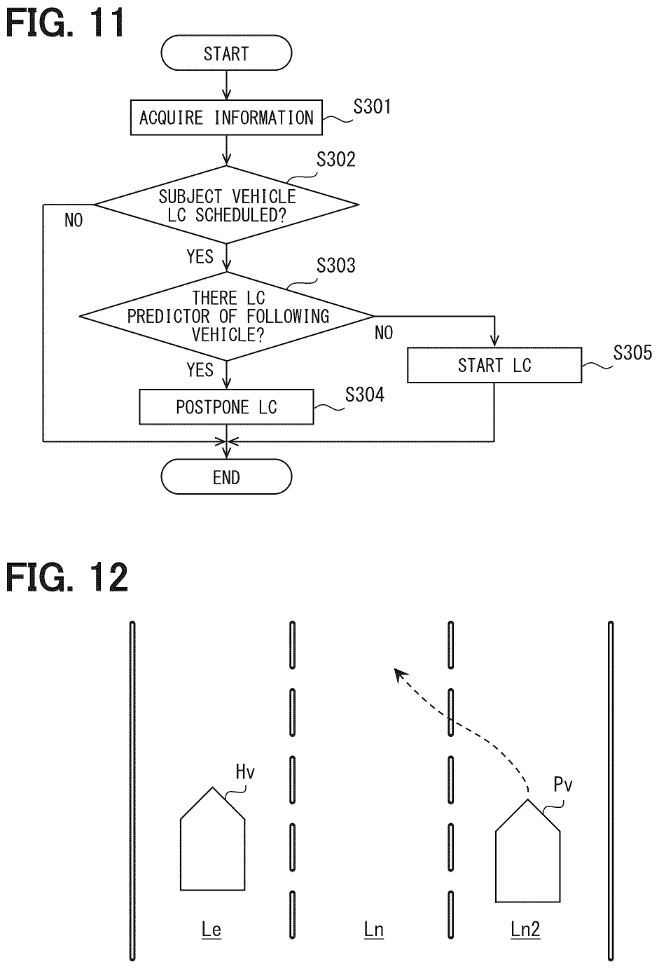

In a configuration in which the vehicle control ECU 30 can automatically execute lane changes, the processor 31 may respond to cancellation/postponement of the lane change of the subject vehicle based on the situation where the following vehicle is about to change lanes. FIG. 11 is a flowchart showing the operation of the processor 31. The process flow can be executed in parallel with, in combination with, or in place of various processes described above. The flow shown in FIG. 11 is executed at a predetermined cycle, such as every 200 milliseconds, while a traveling power supply of the subject vehicle is on or while a shift position is set to a position allowing forward travel. S301 shown in FIG. 11 is the same as S201 described above. S302 is a process for determining whether the subject vehicle is about to change lanes, similar to S203.

S303 is a process for determining whether the following vehicle is about to change lanes, similar to S202. In the present modification, when the processor 31 detects that the following vehicle is also attempting to change lanes in the situation where the vehicle is about to change lanes (YES in S303), the processor 31 postpones the lane change of the subject vehicle (S304). Provisionally, it is determined to start the lane change again after a predetermined time (for example, 5/10 seconds). Provisionally, when the direction signal is currently operating, the direction indicator is temporarily stopped. In addition, when the subject vehicle is attempting to change lanes but the following vehicle is not about to change lanes (YES in S303), the processor 31 starts control for the lane change (S305).

According to the above configuration, it is possible to reduce the risk of the lane change by the subject vehicle at the approximately same time as the following vehicle. Specifically, it is possible to reduce the risk of the subject vehicle changing lanes in a scene in which the following vehicle is about to change lanes. In addition, when it is determined to postpone the execution of the automatic lane change, the processor 31 may inquire of the driver whether to execute the lane change. After notifying the driver of the behavior of the following vehicle by an image or the like, when the driver wishes to start changing lanes, the driver may be requested to input an instruction to that effect. The start instruction of the lane change is acceptable by pressing a steering switch or operating a turn signal lever.

### (Fourth Modification)

Even in a case where the processor 31 determines that the subject vehicle and the following vehicle are about to change lanes at approximately the same time, when the LC direction of the vehicle itself and the LC direction of the following vehicle are different, the processor 31 does not need to execute the following vehicle warning process. The following vehicle warning process may be executed on a condition that the LC direction of the subject vehicle and the LC direction of the following vehicle are the same. According to this configuration, it is possible to reduce the risk of causing inconvenience to the driver. Similarly, the processor 31 may start the automatic lane change when the LC direction of the subject vehicle and the LC direction of the following vehicle differ.

### (Fifth Modification)

As shown in FIG. 12, a distant parallel traveling vehicle is traveling in, among three lanes, a lane sandwiching the intermediate lane with a lane in which the subject vehicle is traveling. In other words, the distant parallel traveling vehicle is traveling in a side area with respect to the subject vehicle. The vehicle control ECU 30 may determine whether the distant parallel traveling vehicle is about to change lanes to the intermediate lane between the subject vehicle and the distant parallel vehicle. In FIG. 12, Pv indicates the distant parallel traveling vehicle, and Ln2 indicates the lane two lanes away from the subject vehicle lane. Le indicates the subject vehicle lane, and Ln indicates the intermediate lane. The intermediate lane is the adjacent lane for the subject vehicle. The distant parallel traveling vehicle is not limited to a vehicle traveling directly beside the subject vehicle, but may be a vehicle that is shifted by approximately 10 meters in the forward or backward direction. The distant parallel traveling vehicle is not limited to a vehicle traveling directly beside the subject vehicle. The distant parallel traveling vehicle also includes other vehicles traveling diagonally ahead and behind the subject vehicle in the next adjacent lanes.

Whether the distant parallel traveling vehicle is about to change lanes to the intermediate lane may be specified by analyzing the image from the side camera, or may be specified based on a signal transmitted from the distant parallel traveling vehicle via the inter-vehicle communication. The processor 31 may determine that the distant parallel traveling vehicle is about to move into the intermediate lane based on the state where the turn signal of the distant parallel traveling vehicle for a direction toward the intermediate lane (toward the subject vehicle) is illuminated. Furthermore, when the processor 31 detects that the distant parallel traveling vehicle is approaching the intermediate lane based on time series data of the vehicle traveling position relative to the lane marking, it may determine that the distant parallel traveling vehicle is about to move into the intermediate lane.

When the vehicle controller F4 detects that the distant parallel traveling vehicle is also about to move into the intermediate lane in a situation where the subject vehicle is about to move into the intermediate lane, the vehicle controller F4 may execute a simultaneous LC warning process. The simultaneous LC warning process is a process for warning that another vehicle is also about to change lanes toward the same lane at the same time as the subject vehicle. The following vehicle warning process described above also corresponds to an example of the simultaneous LC warning process. The simultaneous LC warning process is also executed using one or more of the following: displaying an icon/image on the display 21, outputting a warning sound/message from the speaker 22, and vibrating the vibrator 23.

In a configuration in which the vehicle control ECU 30 can automatically perform lane changes, the processor 31 may cancel/postpone the lane change of the subject vehicle based on the state where the distant parallel traveling vehicle is about to change lanes to the same lane at the same time as the subject vehicle.

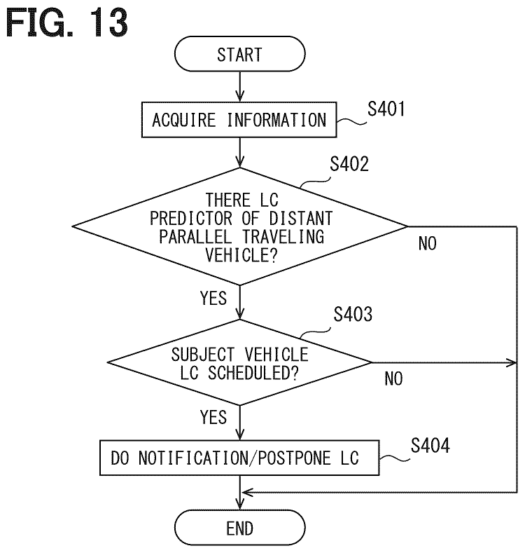

FIG. 13 is a flowchart showing the operation of the processor 31 in the present modification. The process flow shown in FIG. 13 can be executed in parallel with, in combination with, or in place of various processes described above. The flow shown in FIG. 13 may be executed at a predetermined cycle, such as 200 milliseconds, while the traveling power source of the subject vehicle is on and the shift position is set to a position that allows forward travel. S401 shown in FIG. 13 is the same as S201 described above.

Step S402 is a process for determining whether the distant parallel traveling vehicle is about to change lanes to the intermediate lane. The determination in S402 is made based on the operation state of the turn signal and the amount of change over time in the relative position with respect to the lane section markings, which are determined by analyzing the image from the side camera. Of course, the processor 31 may determine whether the distant parallel traveling vehicle is about to change lanes to the intermediate lane based on the content of the signal received from the distant parallel traveling vehicle via the inter-vehicle communication and the change over time in the relative position of the distant parallel traveling vehicle with respect to the subject vehicle. When the processor 31 determines that the distant parallel traveling vehicle is about to change lanes to the intermediate lane, the processor 31 executes S403. On the other hand, when it is not determined that the distant parallel traveling vehicle is about to change lanes into the intermediate lane, this flow ends.

S403 is a process for determining whether the subject vehicle is about to change lanes, similar to S203. When the subject vehicle is about to change lanes (YES in S403), the processor 31 executes the simultaneous LC warning process or postpones the lane change of the subject vehicle.

As described above, depending on the traffic conditions, it may happen that two vehicles of the subject vehicle and the different vehicle, start to change lanes toward the same lane at approximately the same time. The different vehicle here mainly refers to the following vehicle or the distance parallel traveling vehicle. When two vehicles start moving toward the same lane at the same time, the relative positions of the vehicles change rapidly. Therefore, the change may lead to the vehicles coming closer to each other than expected. In such a situation, the configuration of the present disclosure can reduce the risk of the subject vehicle and the different vehicle changing lanes toward the same lane at the same time.

### (First Note)

Detecting the lane change of the following vehicle is an optional element, and the vehicle control device may be configured as follows. The present disclosure also includes the following configurations.

### (First Configuration)

A vehicle control device detects that a distant parallel traveling vehicle traveling two lanes away from the subject vehicle is about to perform the lane change toward a lane of the subject vehicle based on an image captured by a side camera that captures a side area with respect to the subject vehicle, and executes a process to notify the driver of a presence of the distant parallel traveling vehicle when detecting that the distant parallel traveling vehicle is also about to perform the lane change into a lane to which the subject vehicle moves in a situation where the subject vehicle is about to perform the lane change.

### (Second Configuration)

A vehicle control device includes: a different vehicle behavior acquisition unit configured to detect a different vehicle that is about to perform lane change based on a signal from a periphery monitoring sensor that detects a different vehicle traveling in a periphery of the subject vehicle; a vehicle behavior acquisition unit configured to determine whether the subject vehicle is about to perform the lane change of the subject vehicle; and a vehicle controller configured to postpone the lane change of the subject vehicle when the different vehicle that is about to perform the lane change to the lane to which the subject vehicle is about to move is detected in the situation where the subject vehicle is about to perform the lane change.

### (Second Note)

The various flowcharts shown in the present disclosure are all examples, and the number of processes constituting the flowcharts and the execution order of the processes can be changed as appropriate. Further, the device, the system and the method therefor which have been described in the present disclosure may be also realized by a dedicated computer which constitutes a processor programmed to execute one or more functions concretized by computer programs. The device and the method described in the present disclosure may be also implemented by a dedicated hardware logic circuit. Further, the device and the method described in the present disclosure may be also implemented by one or more dedicated computers which are constituted by combinations of a processor for executing computer programs and one or more hardware logic circuits. As the processor (arithmetic core), a CPU, an MPU, a GPU, a DFP (Data Flow Processor), or the like can be adopted. Partial or entire of the functions of the vehicle control ECU 30 may be implemented using a system-on-chip (SoC), an IC, an FPGA, or the like. The concept of IC also includes ASIC (Application Specific Integrated Circuit).

Further, the computer program may be stored in a computer-readable non-transitionary tangible storage medium as an instruction executed by the computer. As a program storage medium, an HDD (Hard-disk Drive), an SSD (Solid State Drive), a flash memory, or the like can be adopted. The scope of the present disclosure also includes programs for causing a computer to function as the vehicle control ECU 30, non-transitory tangible storage mediums such as semiconductor memories which store these programs, and other aspects.

Here, the process of the flowchart or the flowchart described in this application includes a plurality of sections (or steps), and each section is expressed as, for example, S101. Further, each section may be divided into several subsections, while several sections may be combined into one section. Furthermore, each section thus configured may be referred to as a device, module, or means.

What is claimed is:

1. A vehicle control device comprising:
a following vehicle behavior determination unit configured to determine whether a following vehicle, which is a different vehicle in rear of a subject vehicle and traveling in a same lane as the subject vehicle, is about to perform lane change based on a signal from a rear monitoring sensor that outputs information regarding an object existing behind the subject vehicle; and
a vehicle controller configured to execute a following vehicle warning process that is a process of notifying a driver that the following vehicle is about to perform the lane change based on determination, by the following vehicle behavior determination unit, that the following vehicle is about to perform the lane change.

2. The vehicle control device according to claim 1, wherein
the vehicle controller is configured to determine whether the subject vehicle is in a specific state based on a signal from an in-vehicle sensor that detects a state of the subject vehicle or a behavior of the driver,
when the subject vehicle is in the specific state, the vehicle controller executes the following vehicle warning process, and
when the subject vehicle is not in the specific state, the vehicle controller does not execute the following vehicle warning process.

3. The vehicle control device according to claim 2, wherein
a state where a travel speed is equal to or higher than a predetermined value or a state where the subject vehicle is about to perform the lane change is registered as the specific state.

4. The vehicle control device according to claim 2, wherein
a plurality of state patterns are set as the specific state, and
the vehicle controller is configured to change a manner of the following vehicle warning process according to the plurality of state patterns.

5. The vehicle control device according to claim 1, wherein
the following vehicle behavior determination unit is configured to specify a direction in which the following vehicle moves based on the signal from the rear monitoring sensor,
the vehicle controller is configured to
determine whether the subject vehicle is about to perform the lane change based on a signal from an in-vehicle sensor that detects a state of the subject vehicle or a behavior of the driver, and
specify a movement direction of the subject vehicle when the subject vehicle is about to perform the lane change, and
the vehicle controller executes the following vehicle warning process on a condition that both of the subject vehicle and the following vehicle are about to perform the lane change and also the movement direction of the subject vehicle is same as a movement direction of the following vehicle.

6. The vehicle control device according to claim 1, wherein
the following vehicle warning process includes displaying, on a display, a predetermined icon image or a computer graphics image showing that the following vehicle has turned on a turn signal.

7. The vehicle control device according to claim 1, wherein
the following vehicle warning process includes at least one of outputting a predetermined sound from a speaker, vibrating a steering wheel, vibrating a backrest, or tightening a seat belt.

8. The vehicle control device according to claim 1, wherein
the vehicle controller is configured to control automatic lane change of the subject vehicle according to a traffic condition or a traveling schedule set in advance, and
the vehicle controller cancels or postpones the lane change of the subject vehicle when the following vehicle behavior determination unit determines that the following vehicle is about to perform the lane change in a situation where the subject vehicle is about to perform the lane change.

9. A vehicle control device comprising:
a following vehicle behavior determination unit configured to determine whether a following vehicle, which is a different vehicle in rear of a subject vehicle and traveling in a same lane as the subject vehicle, is about to perform lane change based on a signal from a rear monitoring sensor that outputs information regarding an object existing behind the subject vehicle; and
a vehicle controller configured to control automatic lane change of the subject vehicle according to a traffic condition or a traveling schedule set in advance, and
wherein
the vehicle controller cancels or postpones the lane change of the subject vehicle when the following vehicle behavior determination unit determines that the following vehicle is about to perform the lane change in a situation where the subject vehicle is about to perform the lane change.

10. The vehicle control device according to claim 8, wherein
the vehicle controller temporarily holds the automatic lane change of the subject vehicle and requests a driver to input an instruction indicating whether to execute the lane change when the following vehicle behavior determination unit determines that the following vehicle is about to perform the lane change in the situation where the subject vehicle is about to perform the lane change.

11. The vehicle control device according to claim 1, wherein
the rear monitoring sensor is a camera that captures an area behind the subject vehicle, and
the following vehicle behavior determination unit determines that the following vehicle is about to perform the lane change when detecting that a turn signal of the following vehicle is activated by analyzing an image from the camera.

12. The vehicle control device according to claim 1, wherein
the rear monitoring sensor is a camera that captures area behind the subject vehicle, and
the following vehicle behavior determination unit determines that the following vehicle is about to perform the lane change based on an amount of change over time in a relative position between a lane marking and the following vehicle shown in an image of the camera.

13. The vehicle control device according to claim 1, wherein
the rear monitoring sensor detects a position the following vehicle relative to the subject vehicle or a lane marking, and
the following vehicle behavior determination unit determines that the following vehicle is about to perform the lane change based on whether time-series data of position information of the following vehicle corresponds to a predetermined pattern.

14. The vehicle control device according to claim 1, wherein
the rear monitoring sensor detects a relative speed of the following vehicle with respect to the subject vehicle, and
the following vehicle behavior determination unit determines that the following vehicle is about to perform the lane change based on detection that the following vehicle is approaching the subject vehicle at a relative speed equal to or greater than a predetermined value.

15. The vehicle control device according to claim 1, wherein
the vehicle controller is configured to
detect that a distant parallel traveling vehicle traveling two lanes away from the subject vehicle is about to perform the lane change toward a lane of the subject vehicle based on an image captured by a camera that captures a side area with respect to the subject vehicle,
determine whether the subject vehicle is about to perform the lane change into an adjacent lane close to a lane where the distant parallel traveling vehicle exists, based on a signal from an in-vehicle sensor that detects a state of the subject vehicle or a behavior of the driver, and
execute a process to notify the driver of a presence of the distant parallel traveling vehicle when detecting that the distant parallel traveling vehicle is also about to perform the lane change into the adjacent lane in a situation where the subject vehicle is about to perform the lane change into the adjacent lane.

16. A vehicle control method executed by a vehicle control device mounted on a vehicle, the method comprising:
determining whether a following vehicle, which is a different vehicle in a rear of a subject vehicle and traveling in a same lane as the subject vehicle, is about to perform lane change based on a signal from a rear monitoring sensor that outputs information regarding an object existing behind the subject vehicle; and
executing a following vehicle warning process that is a process of notifying a driver that the following vehicle is about to perform the lane change based on determination that the following vehicle is about to perform the lane change.
